(19) United States
(12) Patent Application Publication
(10) Pub. No.: US 2008/0004113 A1
(43) Pub. Date: Jan. 3, 2008

(54) Enhanced controller with modifiable functionality

(76) Inventors: Jason Avery, Berkeley, CA (US); David Hargis, San Jose, CA (US); Paul Rymarz, Pleasanton, CA (US); David Swanson, San Jose, CA (US); Michael P. Much, San Jose, CA (US)

Correspondence Address: WAGNER, MURABITO & HAO LLP, Third Floor, Two North Market Street, San Jose, CA, 95113, US

(21) Appl. No.: 11/479,613

(22) Filed: Jun. 30, 2006

(51) Int. Cl. A63F 13/00

(52) U.S. Cl. 463/37

(57) ABSTRACT

A controller, a method of interacting with a computer-implemented program, and a method for modifying controller functionality. In one embodiment of the present invention, a controller includes a first member and a second member movably coupled with the first member, wherein a movement of the second member with respect to the first member is operable to transform the controller from a first configuration to a second configuration. The controller also includes a plurality of input devices coupled with at least one of the first member and the second member. Additionally, a processor is coupled with and operable to change an operation state of the plurality of input devices and available controller functionality upon detecting the transformation from the first to the second configuration.

### BACKGROUND OF THE INVENTION

Despite the rather limited use of computer systems in the past, advancements in computer-related technologies and overall market acceptance has inundated most every aspect of daily life with computer processors. For example, where the thought of personal computers in the home was once left only to science fiction novels, the average person now relies on processor-driven devices to perform even the simplest tasks around the home. Thus, as the types of interaction with computer systems increases, controllers for those systems require increased functionality to facilitate different forms of user interaction.

To accommodate the need for increased functionality, manufacturers have simply produced additional controllers to fulfill specific needs. For example, it is not uncommon to find five or six remote controls lying on a coffee table for use with home entertainment systems. Similarly, the average computer gamer has multiple game pads, driving wheels and joysticks for interacting with the many types of computer games now available. And although some consumers have come to accept such inconveniences as the price to be paid for advances in technology, an increasing number are shying away from such technology due to the inability to organize and operate the numerous and complex user interfaces included with newer products.

Moreover, even taking into account the collective functionality that numerous controllers on the market may provide, the corresponding user inputs required to complete certain tasks are often unnatural and unintuitive. For example, a user may row a boat in a rowing simulation game by moving a directional pad or joystick of a controller back and forth, which is very different from an actual rowing motion. Similarly, a three-dimensional solid model in a CAD program may be rotated by moving a mouse on a two-dimensional surface. Not only is the mouse articulation unnatural and unintuitive, but it is also used for many other operations within the CAD program (e.g., panning a view, zooming, etc.). Thus, the limited functionality of conventional controllers limits the ability of a user to interact with a coupled computer system, which in turn counteracts the interactivity that modern computer systems strive to provide.

### SUMMARY OF THE INVENTION

Accordingly, a need exists for a controller with expanded functionality. Additionally, a need exists for a controller with modifiable functionality that adapts to receive a user input, where the input may include natural and/or intuitive motion. Embodiments of the present invention provide novel solutions to these needs and others as described below.

Embodiments of the present invention are directed to a controller, a method of interacting with a computer-implemented program, and a method for modifying controller functionality. More specifically, embodiments provide an effective mechanism for increasing controller functionality and adaptability by automatically changing the state of input devices of the controller in response to changes in the controller's physical configuration and/or orientation.

In one embodiment of the present invention, a controller includes a first member and a second member movably coupled with the first member, wherein a movement of the second member with respect to the first member is operable to transform the controller from a first configuration to a second configuration. The first member may be a first half of the controller housing, such that movement of the first member with respect to the second member (e.g., a second half of the controller housing) enables a transition from a first to a second configuration. The controller also includes a plurality of input devices coupled with at least one of the first member and the second member. The input devices may include user interface elements (e.g., buttons, directional pads, joysticks, touch screens, etc.), sensors (e.g., for detecting linear or rotational motion, etc.), or the like. Additionally, a processor is coupled with and operable to change an operation state of the plurality of input devices and available controller functionality upon detecting the transformation from the first to the second configuration. The change in operation state may include enabling, disabling and/or adjusting the input devices such that functionality is expanded and/or adapted based on the configuration of the controller.

In another embodiment of the present invention, a controller includes a housing, a plurality of input devices coupled with the housing, and a processor coupled with and for changing an operation state of the plurality of input devices and available controller functionality upon detecting a change in orientation of the controller. As such, a change in the operation state of the devices (e.g., by enabling, disabling and/or adjusting the input devices) may expand or adapt the functionality of the controller based on its orientation (e.g., with respect to a fixed reference frame).

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a block diagram of an exemplary controller in accordance with one embodiment of the present invention.

FIGS. 2A, 2B and 2C show a transition of an exemplary controller from a first to a second configuration in accordance with one embodiment of the present invention.

FIG. 3 shows an exemplary sensor arrangement for modifying controller functionality in accordance with one embodiment of the present invention.

FIGS. 4A, 4B and 4C show a transition of an exemplary controller from a first to a second configuration in accordance with one embodiment of the present invention.

FIGS. 5A and 5B show the operation state of a plurality of input devices of an exemplary controller when in a first and second configuration in accordance with one embodiment of the present invention.

FIG. 6 shows an exemplary controller and corresponding console in accordance with one embodiment of the present invention.

FIG. 7 shows an exemplary coordinate system with corresponding linear and rotational motion in accordance with one embodiment of the present invention.

FIG. 8 shows a plurality of orientations of an exemplary controller with respect to an exemplary coordinate system in accordance with one embodiment of the present invention.

FIGS. 9A, 9B and 9C show the operation state of a plurality of user inputs of an exemplary controller when in certain orientations in accordance with one embodiment of the present invention.

FIG. 10A shows a computer-implemented process for modifying the functionality of a controller in response to a change in physical configuration in accordance with one embodiment of the present invention.

FIG. 10B shows a computer-implemented process for modifying the functionality of a controller in response to a change in orientation in accordance with one embodiment of the present invention.

FIG. 11 shows a computer-implemented process for interacting with a computer-implemented program in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

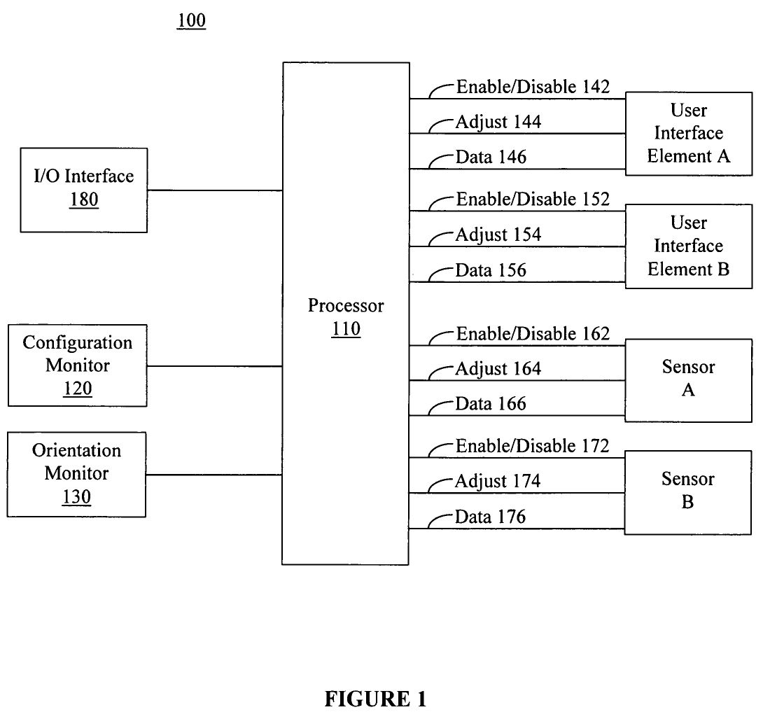

FIG. 1 shows a block diagram of exemplary controller 100 in accordance with one embodiment of the present invention. As shown in FIG. 1, processor 110 is coupled to a plurality of input devices (e.g., user interface element A, user interface element B, sensor A and sensor B) for receiving various types of inputs. The inputs to processor 110 may then be processed and communicated to a coupled computer system (e.g., gaming console, etc.) via input/output (I/O) interface 180 in a wired and/or wireless manner. Additionally, processor 110 may monitor the configuration of controller 100 (e.g., physical configuration) using configuration monitor 120, where monitor 120 is coupled to processor 110. Similarly, orientation monitor 130 is shown coupled to processor 110 for monitoring the orientation of controller 100 (e.g., with respect to a fixed reference frame, previous orientation of the controller, etc.). As such, processor 110 may then change the operation state of one or more of the coupled input devices in response to a change in physical configuration and/or orientation, thereby expanding and/or adapting the functionality of the controller 100 to receive, process and/or communicate different inputs.

Processor 110 is coupled to user interface elements and sensors via separate data buses (e.g., 146, 156, 166 and 176). The data buses coupling a single input device may comprise one or more individual data buses, where each bus may use any analog and/or digital signaling method (e.g., single-ended, differential, etc.). Additionally, data buses 146-176 may utilize either wired or wireless signaling. As such, processor 110 may communicate uni-directionally and/or bi-directionally with the user interface elements and/or sensors such that user and sensory inputs may be appropriately handled by the processor.

As shown in FIG. 1, user interface element A and user interface element B are operable to receive user inputs and communicate them to processor 110, where the elements may be internal or external to controller 100. The user interface elements may comprise any mechanical (e.g., buttons, directional pads, joysticks, touch screens, etc.), electrical (e.g., audio comprising a microphone and/or speaker, etc.) and/or optical user interface. Alternatively, the user interface element may comprise a portion of a user interface (e.g., a portion of a touch screen, etc.). Additionally, the user interface elements may comprise circuitry and/or components necessary to process signals (e.g., digital-to-analog conversion, analog-to-digital conversion, amplification, signal attenuation, etc.) produced by the user interface elements before communication to processor 110. As such, the user interface elements provide flexibility to the controller 100, thereby enabling a user to control a coupled computer system in many ways.

Sensor A and sensor B are operable to receive sensory inputs and communicate them to processor 110, where the sensors may be internal or external to the controller. The sensors may comprise any sensor used for sensing a variety of sensory inputs (e.g., audio, video, tactile, movement, etc.). For example, movement sensors (e.g., accelerometers, gyrometers, gyroscopes, magnetometers, ball-in-cage sensors, etc.) may be used to sense a change in controller position caused by linear or rotational motion. Alternatively, the sensors may be sub-units of a larger sensory device coupled to processor 110. Additionally, the sensors may comprise circuitry and/or components necessary to process signals (e.g., digital-to-analog conversion, analog-to-digital conversion, amplification, signal attenuation, etc.) produced by the sensors before communication to processor 110. As such, the sensors provide flexibility to controller 100, thereby enhancing sensory capabilities of controller 100 and providing users additional means to control a coupled computer system (e.g., by moving the controller, etc.).

As shown in FIG. 1, I/O interface 180 may couple the controller to external computer systems using a wired and/or wireless interface. Where the interface is wireless, it should be appreciated that any wireless signaling technology (e.g., Bluetooth, IEEE 802.11a, IEEE 802.11g, CDMA, WCDMA, TDMA, 3G, LMDS, MMDS, etc.) may be used. As such, controller 100 may use processor 110 to control a computer system coupled via I/O interface 180 by communicating control signals thereto and receiving corresponding signals from the system. For example, where controller 100 is a game controller coupled to a console game system via I/O interface 180, processor 110 may communicate to the game console any received user and/or sensory inputs, thereby enabling a user to interact with a game (e.g., played from the game console and displayed on a display coupled to the console).

Configuration monitor 120 may be used by processor 110 to sense a change in the physical configuration of controller 100. The physical configuration may be defined by the relationship of any two members of the controller with respect to each other. Alternatively, other physical characteristics of the controller (e.g., the coupling of a detachably coupled member, etc.) may define a physical configuration. As such, configuration monitor 120 may sense controller transformations from one physical configuration to another (e.g., with a sensor similar to that described above with respect to sensors A and B) and generate corresponding signals for access by processor 110. Additionally, configuration monitor 120 may comprise circuitry and/or components necessary to process signals (e.g., digital-to-analog conversion, analog-to-digital conversion, amplification, signal attenuation, etc.) produced by configuration monitor 120 before communication to processor 110.

As shown in FIG. 1, orientation monitor 130 may be used by the processor to sense a change in orientation of controller 100. The orientation of controller 100 may be defined with respect to a fixed reference frame (e.g., coordinate system, object, etc.), or alternatively with respect to a previous orientation of controller 100. As such, orientation monitor 130 may sense controller transformations from one orientation to another (e.g., with a magnetometer, ball-in-cage sensor, etc.) and generate corresponding signals for access by processor 110. Additionally, orientation monitor 130 may comprise circuitry and/or components necessary to process signals (e.g., digital-to-analog conversion, analog-to-digital conversion, amplification, signal attenuation, etc.) produced by the orientation monitor 130 before communication to processor 110.

Accordingly, inputs from the configuration and orientation monitors (e.g., 120 and/or 130) may be used by processor 110 to change an operation state of a user input device coupled to the processor 110. For example, user interface elements and/or sensors may be enabled and/or disabled via enable/disable buses 142, 152, 162 and 172. Alternatively, the user interface elements may be adjusted or reconfigured using adjust buses 144, 154, 164 and 174. For example, a user interface and/or sensor may be calibrated. Alternatively, a functional axis of a movement sensor may be flipped, offset, etc. As such, processor 110 may alter the functionality of controller 100 by separately enabling, disabling and/or adjusting coupled input devices, which in turn may modify the control of a coupled computer system by the controller 100.

Although three buses are depicted in FIG. 1 as coupling the input devices to processor 110, it should be appreciated that alternative bus configurations may be used in other embodiments. For example, enable/disable buses may be omitted, where inputs from certain input devices are instead ignored or accepted by processor 110. Additionally, instead of using a discrete adjustment line, logic and/or other components of the processor 110 may be used to adjust signals received from input devices. Moreover, it should be appreciated that any combination of user interface elements and/or sensors may be coupled to processor 110, where a smaller or larger number of input devices may be used.

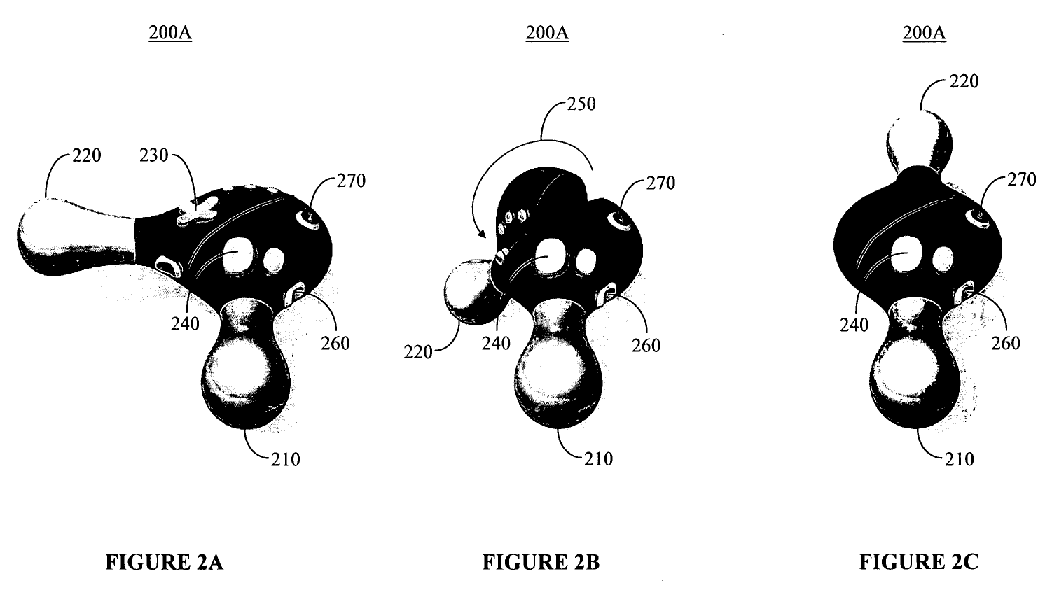

FIGS. 2A, 2B and 2C show a transition of exemplary controller 200A from a first to a second configuration in accordance with one embodiment of the present invention. As shown in FIG. 2A, controller 200A comprises a first member 210 and a second member 220, where member 220 is movably-coupled with member 210. As such, when member 220 is moved (e.g., rotated, slid, etc.) with respect to member 210 (e.g., as shown by arrow 250), controller 200A may be transformed from a first physical configuration as shown in FIG. 2A to a second physical configuration as shown in FIG. 2C.

Although controller 200A is depicted in FIGS. 2A, 2B and 2C with a first and second member which comprise the controller housing, it should be appreciated that in other embodiments controller 200A may include one or more stationary members in addition to members which move with respect to one another. Further, although controller 200A is depicted with only two movable members, it should be appreciated that the controller may have more than two members that move with respect to each other in other embodiments.

As shown in FIGS. 2A, 2B and 2C, controller 200A may include a plurality of input devices. For example, controller 200A has multiple user interface elements (e.g., buttons) whose operation state may be modified by the controller in response to a change in configuration as discussed above with respect to FIG. 1. For example, directional pad 230 and button 240 may be active in the first configuration shown in FIG. 2A. As such, a user may interact with a coupled computer system using pad 230 and button 240 while in the first configuration. However, when placed in the second configuration as shown in FIG. 2C, pad 230 and button 240 may be disabled and/or adjusted to allow interaction via button 260 and/or microphone 270 instead. As such, controller 200A may sense a change in configuration and enable and/or adjust the operation state of button 260 and/or microphone 270, while disabling and/or adjusting the operation state of pad 230 and button 240. In other embodiments, other combinations of user interface elements may be enabled, disabled and/or adjusted in each physical configuration of controller 200A. Moreover, although FIGS. 2A, 2B and 2C depict certain types of user interfaces (e.g., directional pads, buttons, etc.), it should be appreciated that alternative user interfaces (e.g., as discussed above with respect to FIG. 1) may be utilized by controller 200A in other embodiments.

To detect a physical configuration change, controller 200A may use a configuration monitor similar to that discussed above with respect to FIG. 1 (e.g., 120). Each configuration may be denoted by any means (e.g., using a ball detent to denote and maintain configuration positions coupled with a switch for signaling a configuration change, a latch to maintain a given configuration position which may also be coupled to a switch for signaling a configuration change, etc.) such that a configuration change may be identified by components of controller 200A (e.g., a processor) and the functionality of controller 200A may be modified accordingly.

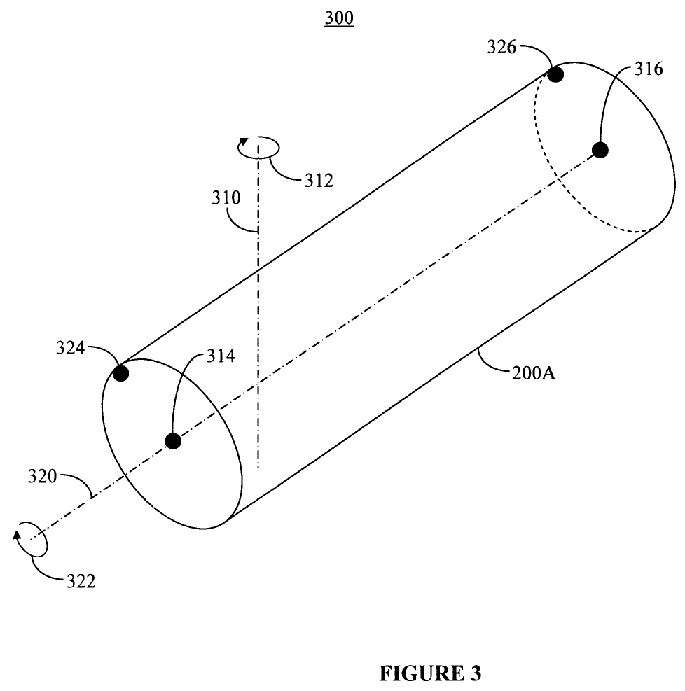

Similarly, controller 200A may change the operation state of any number of coupled sensors to expand and/or adapt the functionality of controller 200A when placed in different configurations (e.g., as discussed above with respect to FIG. 1). Although the sensors of controller 200A are not shown in FIGS. 2A, 2B or 2C, FIG. 3 shows exemplary sensor arrangement 300 for modifying controller functionality in accordance with one embodiment of the present invention. As shown in FIG. 3, controller 200A may include sensors 314 and 316 for detection rotation 312 about axis 310. Additionally, sensors 324 and 326 may be used by controller 200A to detect rotation 322 about axis 320. As such, controller 200A may modify its functionality (e.g., in response to a change in configuration and/or orientation) to enhance reception of inputs (e.g., rotation 312, 322, etc.) to controller 200A. For example, controller 200A may activate and/or adjust the operation state of sensors 314 and 316 while disabling and/or adjusting the operation state of sensors 324 and 326 to enhance the detection (e.g., increase accuracy, resolution, etc.) of rotation 312 about axis 310. Alternatively, the controller may then disable and/or adjust the operation state of sensors 314 and 316 while activating and/or adjusting the operation state of sensors 324 and 326 to enhance the detection of rotation 322 about axis 320.

Additionally, the operation state of sensors of controller 200A may be selectively modified in other embodiments to enhance detection of linear movement in addition to rotational movement. As such, controller 200A enables detection of a wide range of user inputs, where the user inputs may be interaction through user interfaces as described above and/or movements of the controller detected by the coupled sensors. And given the ability of controller 200A to dynamically modify the operation of its sensors, intuitive and natural motions of the controller may be detected for enhanced interaction with a coupled computer system. For example, a user interacting with a game played on a gaming console may simulate the swinging of an object (e.g., bat racket, etc.) by rotating controller 200A about axis 310, whereas rotation of the controller about axis 320 may simulate the turning of a screwdriver. Alternatively, sensors of the controller may be modified to detect movements of the controller such that a user may interact with a displayed program (e.g., by pointing at the display to select items, move items, etc.). Thus, controller 200A may detect such natural movements by dynamically altering the operation state of its sensors, thereby enhancing and adapting the controller functionality to the type of user input received.

Although sensors coupled with controller 200A have been described as detecting motion, it should be appreciated that the sensors may detect other sensory inputs in other embodiments (e.g., as described in FIG. 1 above). Additionally, although only four sensors are depicted in FIG. 3, it should be appreciated that a larger or smaller number of sensors may be utilized in other embodiments.

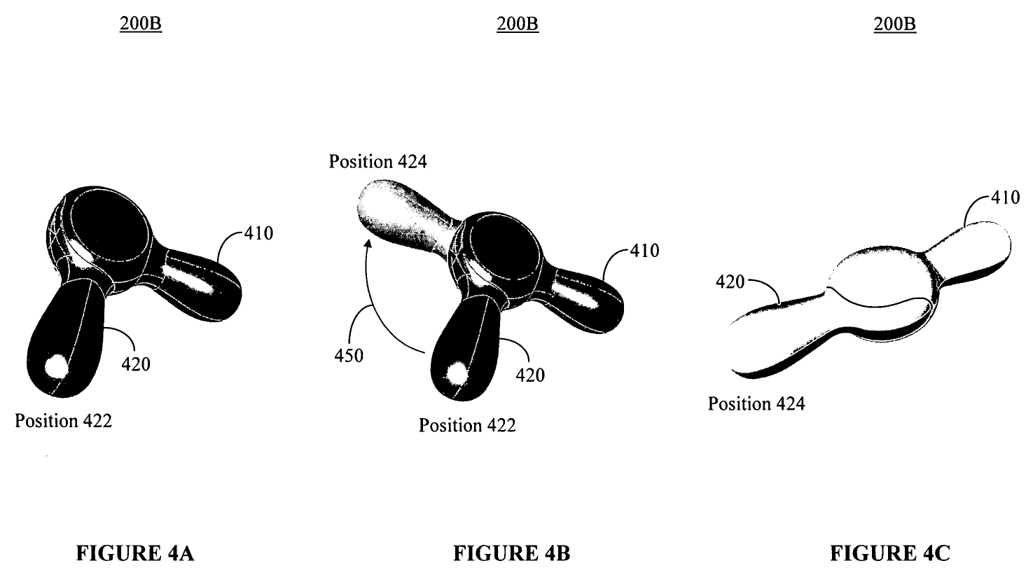

FIGS. 4A, 4B and 4C show a transition of exemplary controller 200B from a first to a second configuration in accordance with one embodiment of the present invention. As shown in FIG. 4A, controller 200B comprises a first member 410 and a second member 420, where member 420 is movably-coupled with member 410. As such, when member 420 is moved (e.g., rotated, slid, etc.) with respect to member 410 (e.g., as shown by arrow 450), controller 200B may be transformed from a first physical configuration as shown in FIG. 4A (e.g., when member 420 is in position 422) to a second physical configuration as shown in FIG. 4C (e.g., when member 420 is in position 424).

Although controller 200B is depicted in FIGS. 4A, 4B and 4C with a first and second member which comprise the controller housing, it should be appreciated that in other embodiments controller 200B may include one or more stationary members in addition to members which move with respect to one another. Further, although controller 200B is depicted with only two movable members, it should be appreciated that the controller may have more than two members that move with respect to each other in other embodiments.

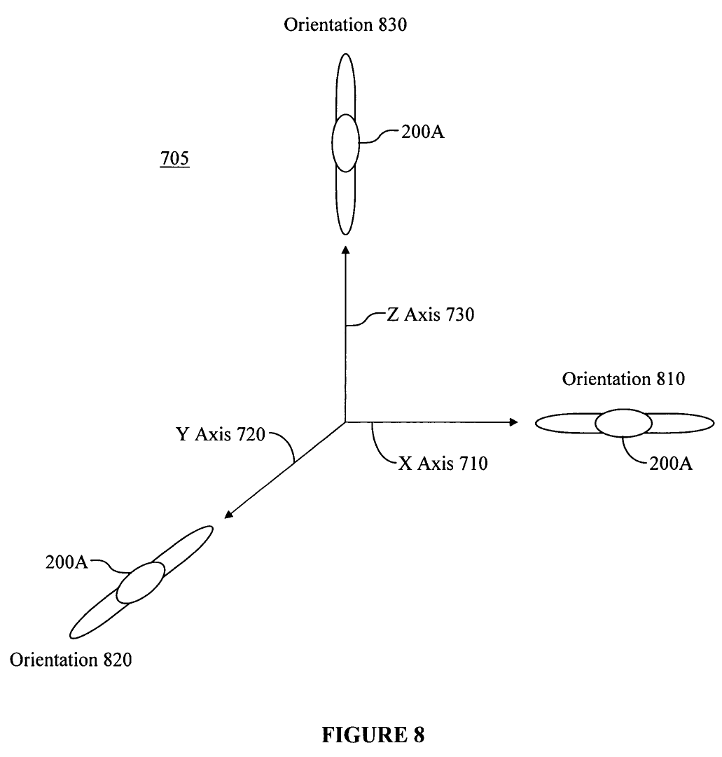

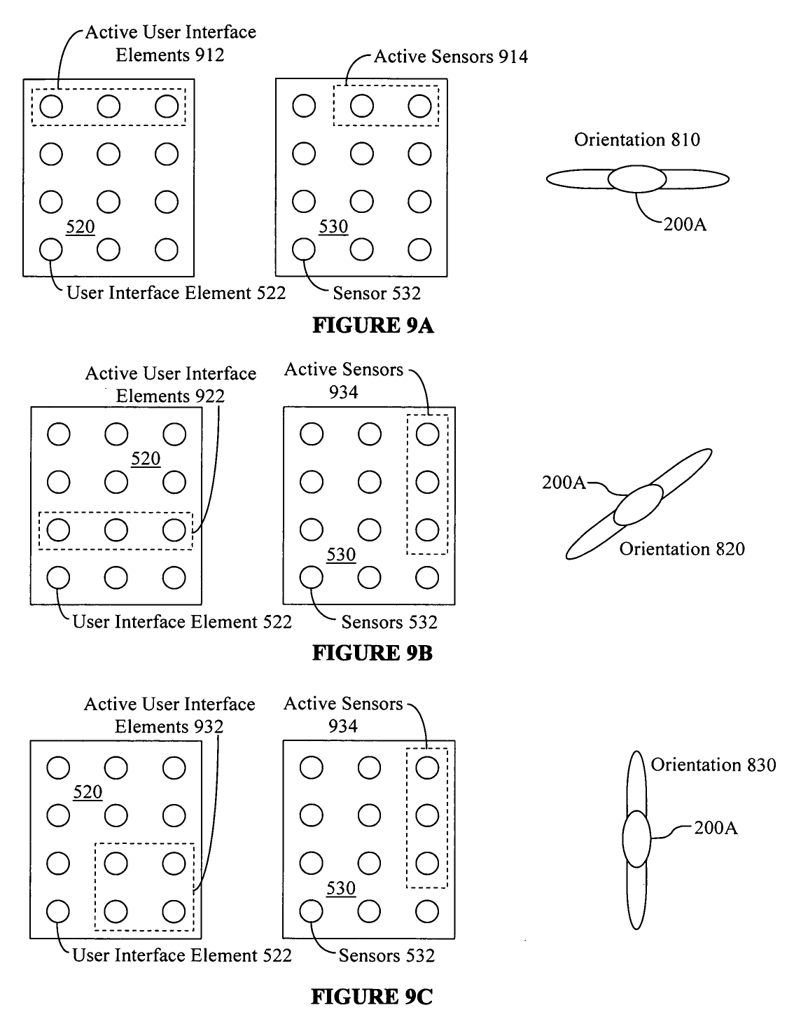

Controller 200B may operate analogously to controller 200A with respect to physical configuration detection, orientation detection (e.g., as described below with respect to FIGS. 8, 9A, 9B, 9C, etc.) and functionality modification. As such, although not depicted in FIGS. 4A, 4B and 4C, controller 200B may include input devices similar to controller 200A and as described with respect to FIG. 1. The state of the input devices may be modified (e.g., enabled, disabled, and/or adjusted) in response to a change in physical configuration and/or orientation, thereby providing controller 200B with enhanced user and sensory input reception when in a given physical configuration and/or orientation.

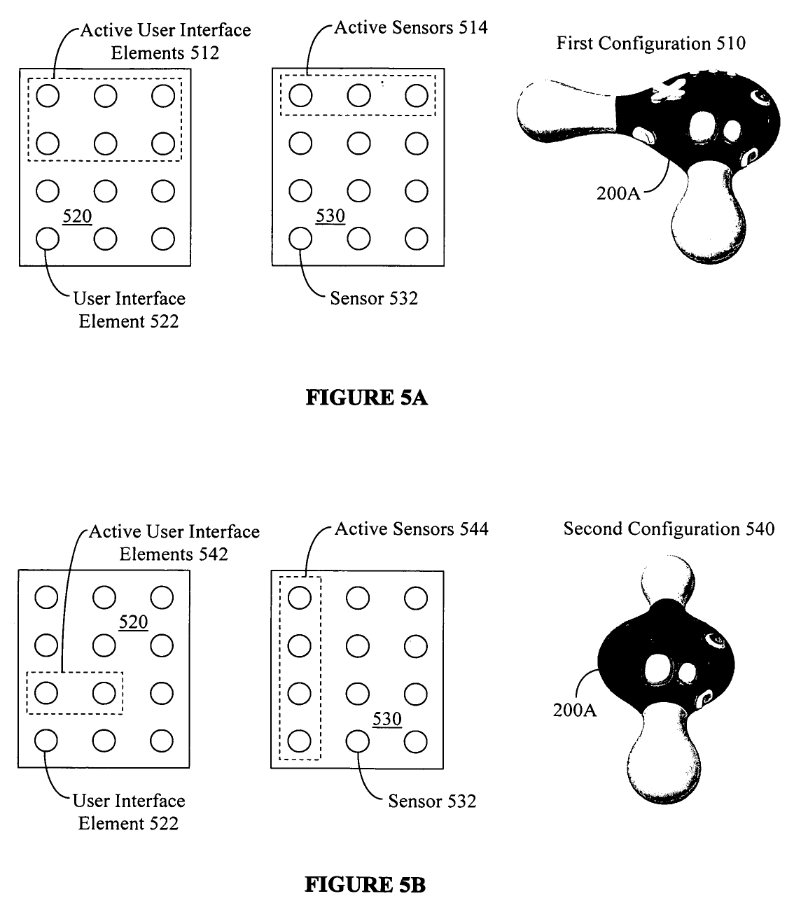

FIGS. 5A and 5B show the operation state of a plurality of input devices of exemplary controller 200A when in a first and second configuration in accordance with one embodiment of the present invention. As shown in FIGS. 5A and 5B, controller 200A includes pool 520 of user interface elements and pool 530 of sensors. Pool 520 comprises a plurality of user interface elements (e.g., 522), which may comprise buttons, touch screens, or other user interface elements (e.g., as described above with respect to FIGS. 1, 2A, 2B, 2C, etc.) for receiving user inputs to controller 200A. Pool 530 comprises a plurality of sensors (e.g., 532), which may comprise mechanical, electrical, optical, or other sensors for receiving sensory inputs to controller 200A.

When controller 200A is placed in first configuration 510 (e.g., as described above with respect to FIG. 2A) as shown in FIG. 5A, a portion of pool 520 (e.g., active user interface elements 512) may be enabled and/or adjusted for enhanced reception of user inputs. Similarly, a portion of pool 530 (e.g., active sensors 514) may be enabled and/or adjusted for enhanced reception of sensory inputs.

Alternatively, when controller 200A is placed in second configuration 540 (e.g., as described above with respect to FIG. 2C) as shown in FIG. 5B, a portion of pool 520 (e.g., active user interface elements 542) may be enabled and/or adjusted for enhanced reception of user inputs. Similarly, a portion of pool 530 (e.g., active sensors 544) may be enabled and/or adjusted for enhanced reception of sensory inputs.

As shown in FIGS. 5A and 5B, the grouping of active input devices in a first and second configuration may overlap (e.g., at least one input is active in both configurations). For example, the sensor shared between active sensors 514 and 544 may remain enabled during the transition, and may or may not be adjusted to receive input in the second configuration. Alternatively, the grouping of active input devices in a first and second configuration may not overlap in other embodiments. For example, no user interface element is shared between active user interface elements 512 and 542, and as such, may be independently enabled, disabled and/or adjusted.

Although FIGS. 5A and 5B depict a specific number of user interface elements (e.g., 522) and sensors (e.g., 532), it should be appreciated that controller 200A may comprise a larger or smaller number of input devices in other embodiments. Similarly, controller 200A may utilize a different number of active input devices in other embodiments. Moreover, it should be appreciated that although FIGS. 5A and 5B depict contiguous groupings of input devices, the active input devices may be of different types (e.g., accelerometers and magnetometers), physical locations within controller 200A, etc.

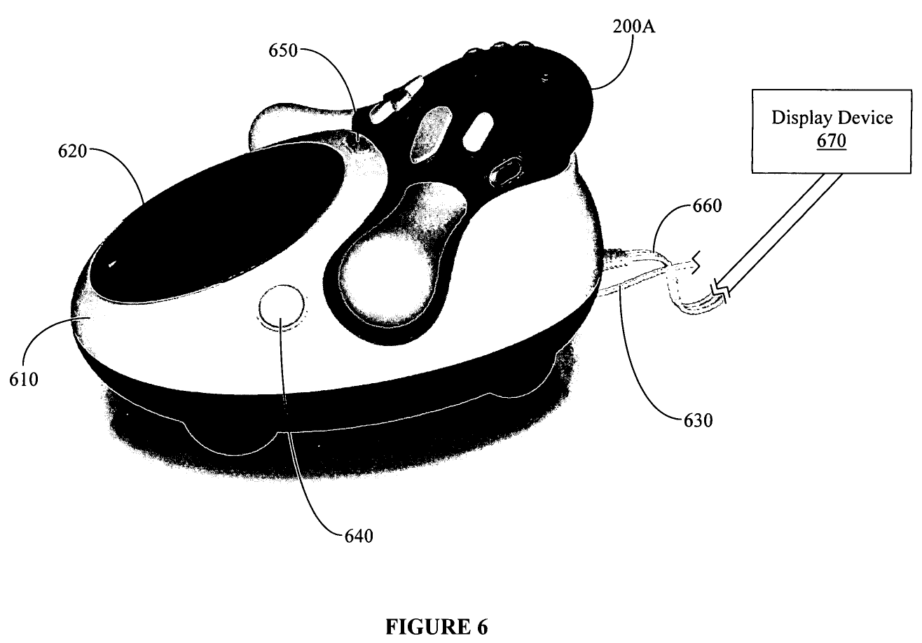

FIG. 6 shows exemplary controller 200A and corresponding console 610 in accordance with one embodiment of the present invention. As shown in FIG. 6, console 610 may comprise a computer system with media access 620 for providing access to data on a storage medium (e.g., CD-ROM, DVD-ROM, etc.) inserted into console 610 (e.g., by a user). Additionally, console 610 comprises power cord 630 for providing power (e.g., AC, DC, etc.) to console 610, where power button 640 may be used to place console 610 in various power states (e.g., on, off, standby, etc.). Additionally, power button 640 may be used in combination with auxiliary input device 650 to interact with controller 200A and a coupled display device 670 (e.g., coupled via interface 660). Input device 650 may comprise a plurality of buttons, touch screens, or the like to enable enhanced interaction with console 610 and/or coupled devices (e.g., controller 200A, display device 670, etc.).

Communication between controller 200A and console 610 may comprise wired and/or wireless communication as discussed above with respect to FIG. 1. As such, controller 200A may be removed from the docked position depicted in FIG. 6 to allow interaction with a program played on console 610 and/or displayed on display device 670. For example, the user may interact with user interfaces of controller 200A and/or articulate controller 200A to provide sensory inputs to controller 200A and/or console 610. As such, where controller 200A uses movement sensors, a user may interact using natural and/or intuitive movements (e.g., as discussed above with respect to FIG. 3) that are detected by the sensors (e.g., whose state may be dynamically modified by controller 200A to enhance reception of the inputs).

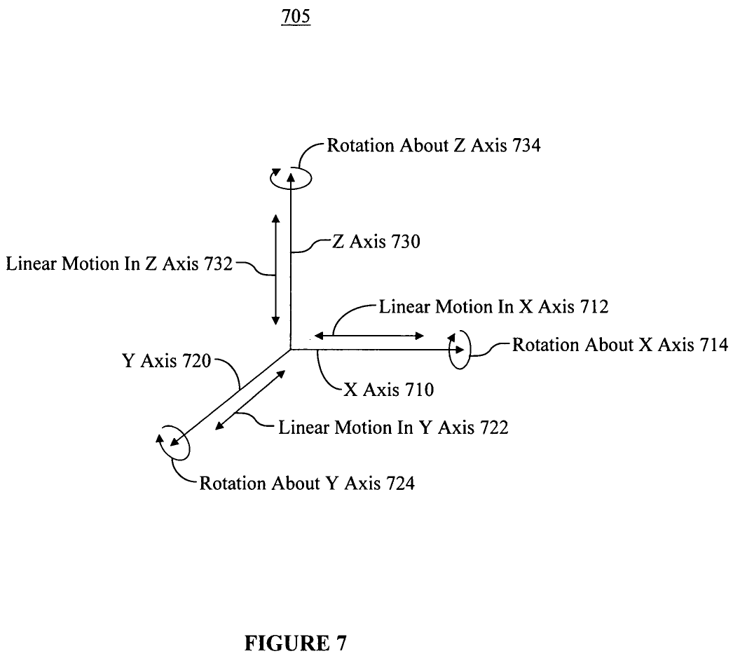

FIG. 7 shows exemplary coordinate system 705 with corresponding linear and rotational motion in accordance with one embodiment of the present invention. As shown in FIG. 7, coordinate system 705 comprises X axis 710, Y axis 720 and Z axis 730, where coordinate system 705 may form a frame of reference for movement with respect thereto. As such, coordinate system 705 may be positioned in any stationary location or with respect to any stationary object (e.g., a display device coupled to a computer system being controlled by controller 200A).

On-axis movement with respect to coordinate system 705 may be linear and/or rotational. For example, linear motion in X axis 712 and/or rotation about X axis 714 may occur with respect to X axis 710. Additionally, linear motion in Y axis 722 and/or rotation about Y axis 724 may occur with respect to Y axis 720. And similarly, linear motion in Z axis 732 and/or rotation about Z axis 734 may occur with respect to Z axis 730. However, off-axis movement may also occur with respect to coordinate system 705, where such movement may be either linear and/or rotational.

FIG. 8 shows a plurality of orientations of exemplary controller 200A with respect to exemplary coordinate system 705 in accordance with one embodiment of the present invention. As shown in FIG. 8, controller 200A may be oriented along X axis 710 in orientation 810, where a central axis of controller 200A (e.g., 320) may be parallel to X axis 710. Alternatively, controller 200A may be oriented along Y axis 720 in orientation 820, where a central axis of controller 200A (e.g., 320) may be parallel to Y axis 720. And in another embodiment, controller 200A may be oriented along Z axis 730 in orientation 830, where a central axis of controller 200A (e.g., 320) may be parallel to Z axis 730. And in yet other embodiments, controller 200A may be oriented in other off-axis orientations with respect to coordinate system 705.

FIGS. 9A, 9B and 9C show the operation state of a plurality of user inputs of exemplary controller 200A when in certain orientations in accordance with one embodiment of the present invention. As shown in FIGS. 9A, 9B and 9C, controller 200A includes pool 520 of user interface elements and pool 530 of sensors as described above with respect to FIGS. 5A and 5B. As such, pool 520 comprises a plurality of user interface elements (e.g., 522) for receiving user inputs to controller 200A. Pool 530 comprises a plurality of sensors (e.g., 532) for receiving sensory inputs to controller 200A.

When controller 200A is placed in orientation 810 (e.g., as described above with respect to FIG. 8) as shown in FIG. 9A, a portion of pool 520 (e.g., active user interface elements 912) may be enabled and/or adjusted for enhanced reception of user inputs. Similarly, a portion of pool 530 (e.g., active sensors 914) may be enabled and/or adjusted for enhanced reception of sensory inputs.

Alternatively, when controller 200A is placed in orientation 820 (e.g., as described above with respect to FIG. 8) as shown in FIG. 9B, a portion of pool 520 (e.g., active user interface elements 922) may be enabled and/or adjusted for enhanced reception of user inputs. Similarly, a portion of pool 530 (e.g., active sensors 924) may be enabled and/or adjusted for enhanced reception of sensory inputs.

And in yet another embodiment, when controller 200A is placed in orientation 830 (e.g., as described above with respect to FIG. 8) as shown in FIG. 9C, a portion of pool 520 (e.g., active user interface elements 932) may be enabled and/or adjusted for enhanced reception of user inputs. Similarly, a portion of pool 530 (e.g., active sensors 934) may be enabled and/or adjusted for enhanced reception of sensory inputs.

As shown in FIGS. 9A, 9B and 9C, the grouping of active input devices in any two orientations may overlap as discussed above with respect to FIGS. 5A and 5B. As such, a plurality of the controller's input devices may remain active (e.g., enabled) during a transition from one orientation to another (e.g., a sensor active in both orientation 810 and 820), where the input devices may or may not be adjusted accordingly. Alternatively, the grouping of active input devices may not overlap in other embodiments, such that a plurality of the input devices may be enabled or disabled accordingly during the transition.

Although FIGS. 9A, 9B and 9C depict a specific number of user interface elements (e.g., 522) and sensors (e.g., 532), it should be appreciated that controller 200A may comprise a larger or smaller number of input devices in other embodiments. Similarly, controller 200A may utilize a different number of active input devices in other embodiments. Moreover, it should be appreciated that although FIGS. 9A, 9B and 9C depict contiguous groupings of input devices, the active input devices may be of different types (e.g., accelerometers and magnetometers), physical locations within controller 200A, etc.

Accordingly, the input devices of controller 200A may be enabled, disabled, and/or adjusted in response to a change in the orientation of controller 200A. A current orientation of the controller may be detected by an orientation monitor (e.g., 130 of FIG. 1), which may use one or more sensors to determine orientation. The input device state modifications made in response to a change in orientation may provide enhanced input reception (e.g., to better detect a given movement as described above with respect to FIG. 3), thereby providing controller 200A with enhanced and/or adapted functionality. Moreover, the functionality modification in response to a change in orientation may be also take into account the current physical configuration of the controller such that reception of user and sensory inputs may be further enhanced.

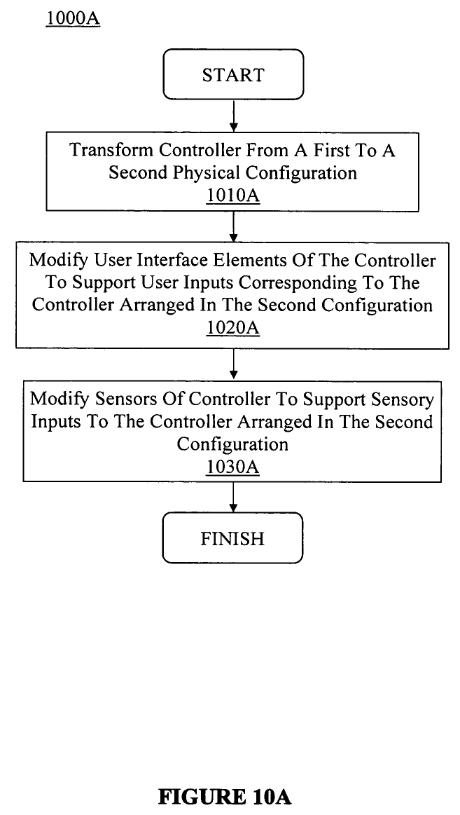

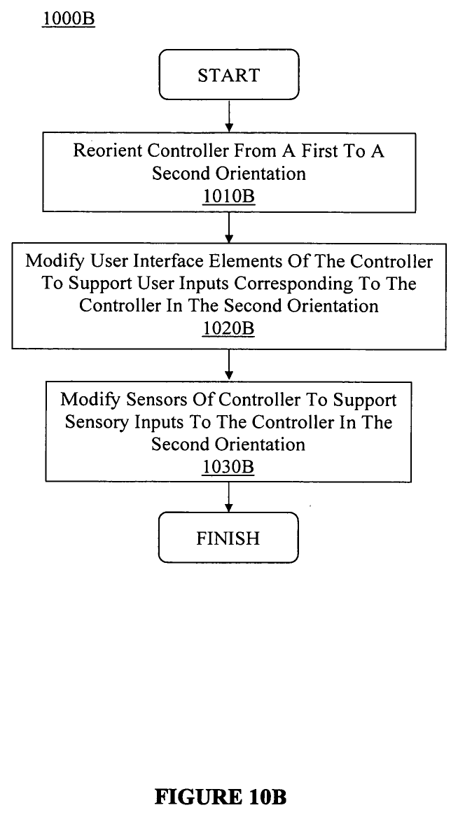

FIG. 10A shows computer-implemented process 1000A for modifying the functionality of a controller (e.g., 100, 200A, 200B, etc.) in response to a change in physical configuration in accordance with one embodiment of the present invention. As shown in FIG. 10A, step 1010A involves transforming a controller from a first physical configuration to a second physical configuration (e.g., by moving one member with respect to another as discussed with respect to FIGS. 1, 2A-2C, 4A-4C, 5A, 5B, etc.).

After transforming the controller to the second configuration, user interface elements of the controller may be modified in step 1020A to support user inputs corresponding to the controller arranged in the second configuration. As discussed above, the user interface elements may be modified by enabling, disabling and/or adjusting the state of the elements. Additionally, the user interface elements may be buttons, touch screens or other interface elements enabling the controller functionality to be modified such that reception of the user inputs via the user interface elements may be enhanced when in the second configuration.

As shown in FIG. 10A, sensors of the controller may be modified in step 1030A to support sensory inputs corresponding to the controller arranged in the second configuration. As discussed above, the user interface elements may be modified by enabling, disabling and/or adjusting the state of the sensors. Additionally, the user interface elements may be mechanical, electrical, optical or other sensors enabling the controller functionality to be modified such that reception of the sensory inputs via the sensors may be enhanced when in the second configuration.

FIG. 10B shows computer-implemented process 1000B for modifying the functionality of a controller in response to a change in orientation in accordance with one embodiment of the present invention. As shown in FIG. 10B, step 1010B involves reorienting a controller (e.g., 100, 200A, 200B, etc.) from a first orientation to a second orientation (e.g., in relation to a given coordinate system as discussed with respect to FIGS. 1, 8, 9A-9C, etc.).

After reorienting the controller to the second orientation, user interface elements of the controller may be modified in step 1020B to support user inputs corresponding to the controller in the second orientation. As discussed above, the user interface elements may be modified by enabling, disabling and/or adjusting the state of the elements. Additionally, the user interface elements may be buttons, touch screens or other interface elements enabling the controller functionality to be modified such that reception of the user inputs via the user interface elements may be enhanced when in the second orientation. As shown in FIG. 10B, sensors of the controller may be modified in step 1030B to support sensory inputs corresponding to the controller in the second orientation. As discussed above, the user interface elements may be modified by enabling, disabling and/or adjusting the state of the sensors. Additionally, the user interface elements may be mechanical, electrical, optical or other sensors enabling the controller functionality to be modified such that reception of the sensory inputs via the sensors may be enhanced when in the second orientation.

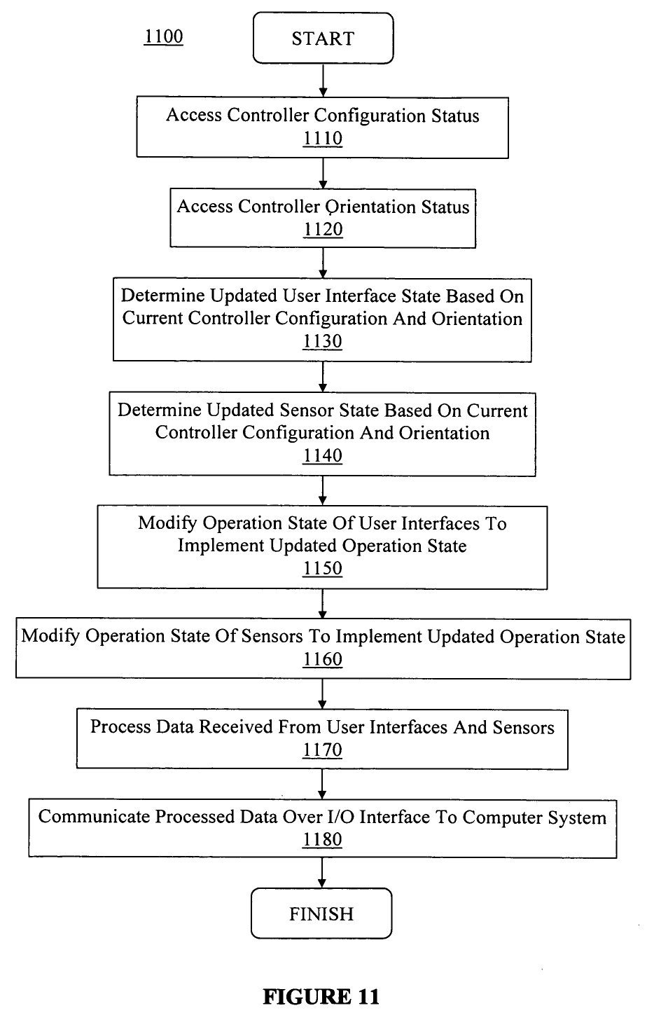

FIG. 11 shows computer-implemented process 1100 for interacting with a computer-implemented program in accordance with one embodiment of the present invention. As shown in FIG. 11, step 1110 involves accessing a configuration status of a controller (e.g., 100, 200A, 200B, etc.). The configuration status may be provided by a configuration monitor (e.g., 120 of FIG. 1), where the monitor is operable to detect a change in physical configuration of the controller (e.g., by moving one member with respect to another as shown in FIGS. 2A-2C, 4A-4C, etc.) and communicate it for access by another component, device, system, etc. (e.g., processor 110 of FIG. 1).

Step 1120 involves accessing an orientation status of a controller (e.g., 100, 200A, 200B, etc.). The orientation status may be provided by an orientation monitor (e.g., 130 of FIG. 1), where the monitor is operable to detect a change in orientation of the controller (e.g., in relation to a given coordinate system as discussed with respect to FIGS. 1, 8, 9A-9C, etc.) and communicate it for access by another component, device, system, etc. (e.g., processor 110 of FIG. 1).

As shown in FIG. 11, an updated operation state of the user interfaces may be determined in step 1130 based on the current controller configuration and orientation (e.g., determined in steps 1110 and 1120). The updated operation state may relate to whether a given user interface of the controller (e.g., 100, 200A, 200B, etc.) should be enabled, disabled, and/or adjusted in response to the current configuration and orientation (e.g., as discussed above with respect to FIG. 1).

Step 1140 involves determining an updated operation state for the sensors based on the current controller configuration and orientation (e.g., determined in steps 1110 and 1120). The updated operation state may relate to whether a given sensor of the controller (e.g., 100, 200A, 200B, etc.) should be enabled, disabled, and/or adjusted in response to the current configuration and orientation (e.g., as discussed above with respect to FIGS. 1, 3, etc.).

After determining an updated state for user interfaces of the controller (e.g., in step 1130), the operation state of the user interfaces may be modified in step 1150 to implement the updated operation states. For example, the user interfaces of the controller may be enabled, disabled and/or adjusted to enhance reception of user inputs to the controller (e.g., 100, 200A, 200B, etc.) in the current configuration and orientation.

As shown in FIG. 11, the operation state of the sensors may be modified in step 1160 to implement the updated operation states (e.g., as determined in step 1140). For example, the sensors of the controller may be enabled, disabled and/or adjusted to enhance reception of sensory inputs to the controller (e.g., 100, 200A, 200B, etc.) in the current configuration and orientation.

After implementing updated operation states of the controller's input devices, data received from user interfaces and sensors may be processed in step 1170. As described with respect to FIG. 1 above, the data may be communicated to a processor (e.g., 110 of FIG. 1) of the controller (e.g., 100 of FIG. 1) over data buses (e.g., 146-176 of FIG. 1) for processing. Alternatively, components of the user interfaces and/or sensors may perform preliminary processing before communicating the resulting data to a processor (e.g., 110 of FIG. 1) of the controller (e.g., 100 of FIG. 1) for subsequent processing. Thereafter, the processed data may be communicated over an I/O interface (e.g., 180 of FIG. 1) coupling the controller to a computer system for effectuating control of the coupled computer system. For example, where the computer system is a gaming console, information communicated by the controller (e.g., processed user and sensory inputs from input devices in modified operation states) may enable a user to interact with a game played on the console (e.g., 610 of FIG. 6) and displayed on a display device (e.g., 670 of FIG. 6) coupled to the console.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A controller comprising:
a first member;
a second member movably coupled with said first member, wherein a movement of said second member with respect to said first member is operable to transform said controller from a first configuration to a second configuration;
a plurality of input devices coupled with at least one of said first member and said second member; and
a processor coupled with and for changing an operation state of said plurality of input devices and available controller functionality upon detecting said transformation from said first to said second configuration.

2. The controller of claim 1, wherein said plurality of input devices comprise a plurality of user interface elements and a plurality of sensors.

3. The controller of claim 1, wherein said plurality of input devices comprise a first user interface element and a second user interface element, and wherein said processor is operable to separately control an enabled state of said first user interface element and said second user interface element.

4. The controller of claim 1, wherein said plurality of input devices comprise a first user interface element and a second user interface element, and wherein said processor is operable to separately adjust said first user interface element and said second user interface element.

5. The controller of claim 1, wherein said plurality of input devices comprise a plurality of computer-implemented game controls, said controls comprising a plurality of buttons for interacting with a computer-implemented game.

6. The controller of claim 1, wherein said plurality of input devices comprise a first sensor and a second sensor, and wherein said processor is operable to separately control an enabled state of said first sensor and said second sensor.

7. The controller of claim 1, wherein said plurality of input devices comprise a first sensor and a second sensor, and wherein said processor is operable to separately adjust said first sensor and said second sensor.

8. The controller of claim 1, wherein said plurality of input devices comprise a plurality of accelerometers for detecting movement of said controller and for interacting with a computer-implemented game.

9. The controller of claim 1 further comprising a monitoring component for identifying said transformation and transmitting a signal to said processor to enable said detecting of said transformation.

10. A controller comprising:
a housing;
a plurality of input devices coupled with said housing; and
a processor coupled with and for changing an operation state of said plurality of input devices and available controller functionality upon detecting a change in orientation of said controller.

11. The controller of claim 10, wherein said housing comprises a first member and a second member, wherein said second member is movably coupled with said first member, and wherein a movement of said second member with respect to said first member is operable to transform said controller from a first configuration to a second configuration; and
wherein said processor is further operable to change an operation state of said plurality of input devices and available controller functionality upon detecting said transformation from said first to said second configuration.

12. The controller of claim 10, wherein said plurality of input devices comprise a plurality of user interface elements and a plurality of sensors.

13. The controller of claim 10, wherein said plurality of input devices comprise a first user interface element and a second user interface element, and wherein said processor is operable to separately control an enabled state of said first user interface element and said second user interface element.

14. The controller of claim 10, wherein said plurality of input devices comprise a first user interface element and a second user interface element, and wherein said processor is operable to separately adjust said first user interface element and said second user interface element.

15. The controller of claim 10, wherein said plurality of input devices comprise a plurality of computer-implemented game controls, said controls comprising a plurality of buttons for interacting with a computer-implemented game.

16. The controller of claim 10, wherein said plurality of input devices comprise a first sensor and a second sensor, and wherein said processor is operable to separately control an enabled state of said first sensor and said second sensor.

17. The controller of claim 10, wherein said plurality of input devices comprise a first sensor and a second sensor, and wherein said processor is operable to separately adjust said first sensor and said second sensor.

18. The controller of claim 10, wherein said plurality of input devices comprise a plurality of accelerometers for detecting movement of said controller and for interacting with a computer-implemented game.

19. The controller of claim 10 further comprising a magnetometer coupled to said processor and operable to detect said change in orientation of said controller.

20. A method for interacting with a computer-implemented program comprising:
accessing a configuration status of a controller, wherein said configuration status is determined by a positioning of a first member of said controller with respect to a second member of said controller;
implementing an updated state of a plurality of input devices of said controller based upon a change in said configuration status; and
communicating to a coupled computer system an input received by one of said plurality of input devices in said updated state, wherein said communicating enables interaction with said computer-implemented program.

21. The method of claim 20 further comprising:
accessing an orientation of said controller; and
implementing said updated state based further upon a change in said orientation of said controller.

22. The method of claim 20, wherein said plurality of input devices comprise a plurality of user interface elements.

23. The method of claim 22, wherein said implementing an updated state further comprises changing an enabled state of said plurality of user interface elements.

24. The method of claim 22, wherein said implementing an updated state further comprises adjusting said plurality of user interface elements.

25. The method of claim 22, wherein said plurality of input devices comprise a plurality of computer-implemented game controls, said controls comprising a plurality of buttons.

26. The method of claim 20, wherein said plurality of input devices comprise a plurality of sensors.

27. The method of claim 26, wherein said implementing an updated state further comprises changing an enabled state of said plurality of sensors.

28. The method of claim 26, wherein said implementing an updated state further comprises adjusting said plurality of sensors.

29. The method of claim 26, wherein said plurality of sensors comprise a plurality of accelerometers for detecting movement of said controller.

30. The method of claim 20, wherein said change in said orientation is detected by a magnetometer coupled to said controller.

31. A method for modifying controller functionality comprising:
adjusting said controller from a first physical configuration to a second physical configuration;
modifying a first plurality of user interface elements of said controller to support a first plurality of user inputs corresponding to said controller arranged In said second physical configuration; and
modifying a first plurality of sensors of said controller to support a first plurality of sensor inputs corresponding to said controller arranged In said second physical configuration.

32. The method of claim 31 further comprising:
adjusting said controller from a first orientation to a second orientation;
modifying a second plurality of user interface elements of said controller to support a second plurality of user inputs corresponding to said controller arranged In said second orientation; and
modifying a second plurality of sensors of said controller to support a second plurality of sensor inputs corresponding to said controller arranged In said second orientation.

33. The method of claim 31, wherein said first and second plurality of user interface elements comprise at least one button enabling a user to interact with a computer-implemented game.

34. The method of claim 32, wherein said first plurality and said second plurality of user interface elements share at least one user interface element in common.

35. The method of claim 32, wherein said first plurality and said second plurality of sensors share at least one sensor in common.
